(19) United States
(12) Patent Application Publication
(10) Pub. No.: US 2025/0189794 A1
(43) Pub. Date: Jun. 12, 2025

(54) CAPTURING INFRARED LIGHT AND VISIBLE LIGHT WITH CAMERA

(71) Applicant: GOOGLE LLC, Mountain View, CA (US)

(72) Inventor: Ian Muldoon, Brookdale, CA (US)

(21) Appl. No.: 18/535,602

(22) Filed: Dec. 11, 2023

(51) Int. Cl. G02B 27/01; G02B 27/00; G06F 3/01

(52) U.S. Cl. CPC G02B 27/0172; G02B 27/0093; G02B 27/0101; G06F 3/013; G02B 2027/0138; G02B 2027/0178

(57) ABSTRACT

A head-mounted device comprises a frame; a lens coupled to the frame, the lens being configured to reflect infrared light from an interior side of the lens and pass visible light; and a camera configured to capture the infrared light reflected from the interior side of the lens and to capture the visible light passing through the lens.

### TECHNICAL FIELD

This description relates to capturing optical data.

### BACKGROUND

Head-mounted devices can have a camera that captures images of objects external to the head-mounted device and another camera that captures images of an eye of a user who is wearing the camera.

### SUMMARY

An apparatus, such as a head-mounted device, includes a camera that captures both visible light that passes through a lens and infrared light that reflects off of the lens. The lens reflects the infrared light from an interior side of the lens and passes visible light.

According to an example, a head-mounted device comprises a frame; a lens coupled to the frame, the lens being configured to reflect infrared light from an interior side of the lens and pass visible light; and a camera configured to capture the infrared light reflected from the interior side of the lens and to capture the visible light passing through the lens.

According to an example, a method performed by a head-mounted device comprises capturing, by a camera included in the head-mounted device, infrared light reflected off of a lens included in the head-mounted device, the infrared light including an image of an eye; determining, by a processor included in the head-mounted device based on the image of the eye, a direction of a gaze of the eye; capturing, by a camera included in the head-mounted device, visible light passing through the lens included in the head-mounted device, the visible light including an image of an object beyond the lens included in the head-mounted device; and determining motion of the head-mounted device based on the image of the object.

According to an example, a non-transitory computer-readable storage medium comprises instructions stored thereon. When executed by at least one processor, the instructions are configured to cause a head-mounted device to capture, by a camera included in the head-mounted device, infrared light reflected off of a lens included in the head-mounted device, the infrared light including an image of an eye; determine, based on the image of the eye, a direction of a gaze of the eye; capture, by the camera included in the head-mounted device, visible light passing through the lens included in the head-mounted device, the visible light including an image of an object beyond the lens included in the head-mounted device; and determine motion of the head-mounted device based on the image of the object.

The details of one or more implementations are set forth in the accompanying drawings and the description below. Other features will be apparent from the description and drawings, and from the claims.

### BRIEF DESCRIPTION OF THE DRAWINGS

FIG. 1 is a perspective view of an apparatus that includes a lens that reflects infrared light from an interior side of the lens and passes visible light and a camera that captures the infrared light and the visible light.

FIG. 2A shows infrared light transmitted from an illuminator and reflecting off of the interior side of the lens onto an eye of a user.

FIG. 2B shows the infrared light scattering off of the eye of the user and reflecting off of the interior side of the lens onto the camera.

FIG. 3 shows visible light reflecting off of an object, through the lens, onto the camera.

FIG. 4 shows a filter included in the camera.

FIG. 5 shows the lens with a concave shape.

FIG. 6 shows the user wearing the apparatus and objects around the user.

FIGS. 7A, 7B, and 7C show an implementation of a head-mounted device.

FIG. 7D shows another implementation of the head-mounted device.

FIG. 8 shows the head-mounted device communicating with a computing device that is external to the head-mounted device.

FIG. 9 shows a method performed by the apparatus.

Like reference numbers refer to like elements.

### DETAILED DESCRIPTION

Head-mounted devices, such as augmented reality glasses, can include an external camera that captures images of objects in front of a user wearing the head-mounted device as well as a gaze-tracking camera that captures images of an eye of the user. A technical problem with including both the external camera and the gaze-tracking camera in the head-mounted device is that two cameras add weight and expense, and the external camera occupies space on a front portion of the head-mounted device. A technical solution to the technical problem with including two cameras is to capture images of the objects in front of the user and images of the eye with a same, single camera. A lens included in the head-mounted device reflects infrared light and passes visible light. The single camera captures infrared light images of the eye that are reflected off of the lens and captures visible light images of external objects that pass through the lens. A technical benefit of capturing the images of external objects and the eye with a single camera is reduced weight, reduced space occupied by the single camera, and reduced cost.

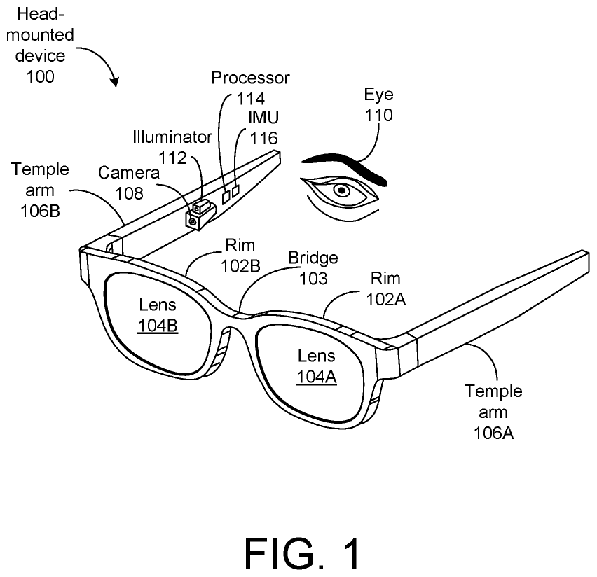

FIG. 1 is a perspective view of an apparatus that includes a lens 104B that reflects infrared light from an interior side of the lens 104B and passes visible light and a camera 108 that captures the infrared light and the visible light. In the example shown in FIG. 1, the apparatus is a head-mounted device 100. The head-mounted device 100 includes a frame. The frame includes a left rim 102A, a bridge 103 coupled to the left rim 102A, and a right rim 102B coupled to the bridge 103. When the head-mounted device 100 is worn by a user, the left rim 102A is in front of a left eye of the user and the right rim 102B is in front of a right eye of the user. In the example shown in FIG. 1, the right eye is represented by an eye 110. While the eye 110 is shown displaced from the lens 104B in FIG. 1 for illustrative purposes, when the head-mounted device 100 is worn by a user the eye 110 will be close to the lens 104B. A left temple arm 106A is hingedly attached to the left rim 102A. A right temple arm 106B is hingedly attached to the right rim 102B.

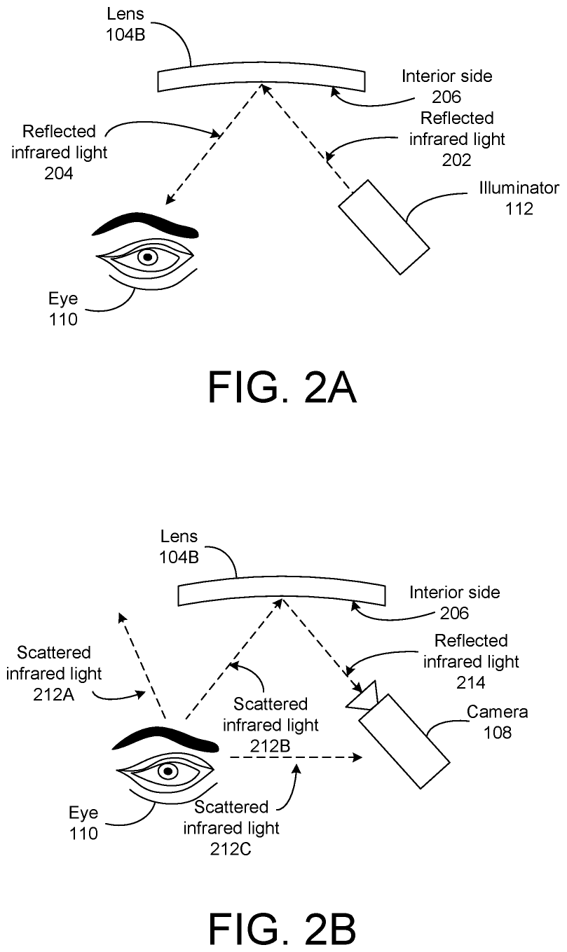

The head-mounted device 100 includes one or more lenses, such as a left lens 104A supported by and/or coupled to the frame and/or the left rim 102A and a right lens 104B supported by and/or coupled to the frame and/or right rim 102B. The one or more lenses are configured to reflect infrared light from an interior side of the lens and to pass visible light through the lens. Infrared light can be electromagnetic radiation in a spectral band between microwaves and visible light. Visible light can be electromagnetic radiation that can be perceived by a human eye, and can have wavelengths between infrared and ultraviolet. In the example shown in FIG. 1, the lens 104B is configured to reflect infrared light from an interior side (labeled in FIGS. 2A and 2B) of the lens 104B. In the example shown in FIG. 1, the lens 104B is configured to allow visible light to pass through the lens 104B. In some examples, the one or more lenses include a hot mirror on the interior side of the lens.

The head-mounted device 100 includes a camera 108. In some implementations, the camera 108 is coupled to one of the temple arms 106A, 106B, such as to the right temple arm 106B. While the camera 108 is shown extending from the right temple arm 106B in FIG. 1 for illustrative purposes, the camera 108 can be embedded in the right temple arm 106B so that the camera 108 will not rub or scrape against a head of the user when the user is wearing the head-mounted device 100. In some examples, the head-mounted device 100 includes two cameras, with a first camera coupled to the left temple arm 106A and a second camera coupled to the right temple arm 106B. The two cameras both capture infrared light with images of the respective eye and visible light with images of one or more external objects. In some implementations, the camera 108 is included in and/or coupled to other portions of the head-mounted device 100, such as the frame and or a rim 102A, 102B.

The camera 108 captures the infrared light reflected from the interior side of the lens 104B. Capturing the infrared light reflected from the interior side of the lens 104B enables the camera 108 to capture one or more images of the eye 110. The camera 108 captures visible light passing through the lens 104B. Capturing visible light passing through the lens 104B enables the camera 108 to capture one or more images of one or more objects beyond and/or external to the head-mounted device 100.

In some examples, the head-mounted device 100 includes an illuminator 112. While the illuminator 112 is shown attached to the camera 108 and interior to the camera 108 in FIG. 1 for illustrative purposes, the illuminator 112 can be embedded in the right temple arm 106B so that the illuminator 112 will not rub or scrape against a head of the user when the user is wearing the head-mounted device 100. The head-mounted device 100 can include one or more illuminators. The number of illuminators can correspond to the number of cameras included in the head-mounted device 100. If the head-mounted device 100 includes one camera mounted to one of the temple arms 106A, 106B (such as the one camera 108 mounted to the right temple arm 106B shown in FIG. 1), then the head-mounted device 100 can include a single illuminator. If the head-mounted device 100 includes two cameras, with one camera supported by and/or coupled to each of the two temple arms 106A, 106B, then the head-mounted device 100 can include two illuminators, with one illuminator supported by and/or coupled to each of the two temple arms 106A, 106B.

The one or more illuminators, such as the illuminator 112, can be an infrared light source. The illuminator 112 projects and/or transmits infrared light onto the interior portion of the lens 104B. The infrared light projected and/or transmitted onto the interior portion of the lens 104B reflects off of the interior portion of the lens 104B and onto the eye 110. The infrared light reflected onto the eye 110 scatters off of the eye 110 onto the lens 104B, and reflects off of the interior portion of the lens 104B onto the camera 108. The camera 108 is thereby able to capture one or more infrared images of the eye 110.

In some examples, the head-mounted device 100 includes a processor 114. The processor 114 can perform operations based on data captured by the camera 108. In some examples, the processor 114 can determine a gaze direction of the eye 110 based on the infrared light images of the eye and/or infrared light captured by the camera 108. In some examples, the processor 114 can determine an orientation and/or motion of the head-mounted device 100 based on visible light images of objects and/or visible light captured by the camera 108. In some examples, the processor 114 is near the camera 108, such as supported by and/or coupled to the same right temple arm 106B as the camera 108.

In some examples, the head-mounted device 100 includes an accelerometer and/or gyroscope, which can be included in an inertial measurement unit (IMU) 116. The IMU 116 can determine a specific force, angular rate, and/or orientation of the head-mounted device 100 and/or a portion of the head-mounted device 100 that the IMU 116 is supported by and/or coupled to (such as the right temple arm 106B). In some examples, the IMU 116 is supported by and/or coupled to the same portion of the head-mounted device 100 as the camera 108 and/or processor 114, such as to the right temple arm 106B. In some examples, the processor 114 determines the orientation and/or motion of the head-mounted device 100 based on visible light images of objects and/or visible light captured by the camera 108 as well as the specific force, angular rate, and/or orientation determined by the IMU 116.

FIG. 2A shows infrared light transmitted from the illuminator 112 and reflecting off of the interior side 206 of the lens 104B onto the eye 110 of a user. The illuminator 112 projects and/or transmits infrared light 202 onto the interior side 206 of the lens 104B. The transmitted infrared light 202 can have wavelengths between 750 nanometers and 100 micrometers. The illuminator 112 is an infrared light source aiming at the interior side 206 of the lens 104B. The interior side 206 of the lens 104B reflects infrared light 204. Reflected infrared light 204 is a reflection of the transmitted infrared light 202 that reflects off of the interior side 206. The reflected infrared light 204 can have a same wavelength and/or wavelengths as the transmitted infrared light 202. The interior side 206 can include a hot mirror that reflects infrared light and passes visible light wavelengths. In some examples, the hot mirror covers the entire interior side 206 of the lens 104B. In some examples, the hot mirror covers a portion of the interior side 206 of the lens 104B. At least a portion of the transmitted infrared light 202 that reflects off of the interior side 206 of the lens 104B will arrive at the eye 110 in the form of reflected infrared light 204.

FIG. 2B shows the infrared light 212A, 212B, 212C scattering off of the eye 110 of the user and reflecting off of the interior side 206 of the lens 104B onto the camera 108. The reflected infrared light 204 that arrives at the eye 110 will scatter in multiple directions, in the form of scattered infrared light 212A, 212B, 212C. The scattered infrared light 212A, 212B, 212C can have a same wavelength and/or wavelengths as the reflected infrared light 204. A portion of this scattered infrared light 212A, 212B, 212C, denoted scattered infrared light 212B, will scatter toward the interior side 206 of the lens 104B in a direction that causes the scattered infrared light 212B to reflect off of the interior side 206 of the lens 104B toward the camera 108. The portion of the scattered infrared light 212B that is reflected toward the camera 108 can be considered reflected infrared light 214. The reflected infrared light 214 can have a same wavelength and/or wavelengths as the scattered infrared light 212B. The camera 108 can capture the reflected infrared light 214. The reflected infrared light 214 can include one or more images of the eye 110. The camera 108 can capture one or more images of the eye 110 based on the reflected infrared light 214.

In some examples, the camera 108 and/or a processor in communication with the camera 108 (such as the processor 114) crops a portion of the image captured by the camera 108. The camera 108 and/or processor can crop the portion (or portions) of the image captured by the camera 108 that does not include an image of the eye 110. Cropping a portion (or portions) of the image captured by the camera 108 that does not include the image of the eye 110 reduces memory consumption, reduces processing complexity, and/or enables an increase of a frame rate of capturing and/or processing images of the eye 110.

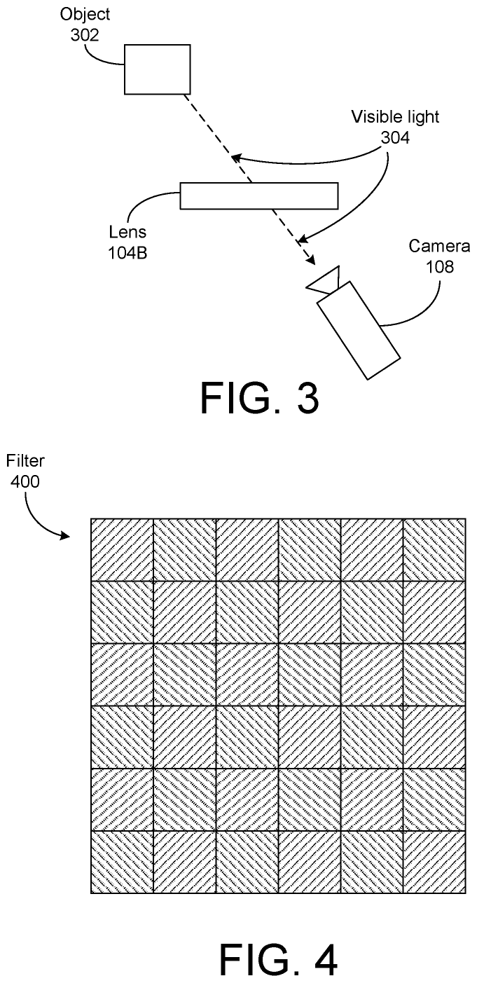

FIG. 3 shows visible light 304 reflecting off of an object 302, through the lens 104B, onto the camera 108. The visible light 304 can reflect and/or scatter off of the object 302. The visible light 304 can have a wavelength and/or wavelengths in the range of 400 nanometers to 700 nanometers. The visible light 304 that reflects and/or scatters off of the object 302 can originate from a light source external to the head-mounted device 100 (not labeled in FIG. 3), or from the head-mounted device 100 in an example in which the head-mounted device 100 includes a light for illuminating external objects. The visible light 304 passes through the lens 104B and arrives at the camera 108. The camera 108 captures one or more images of the object 302. While one object 302 is shown in FIG. 3, the camera 108 can capture images of multiple objects from which visible light reflects and/or scatters, passes through the lens 104B, and arrives at the camera 108. The camera 108 can maintain a wide field of view when capturing visible light to capture images of multiple objects. The wide field of view can be implemented by a fisheye lens included in the camera 108.

In some examples, the camera 108 adjusts a focus distance between a distance between the camera 108 and the eye 110 and a distance between the camera 108 and the object 302. A first distance, the distance between the camera 108 and the eye 110, can be a sum of a distance that the scattered reflected light 212B traveled from the eye 110 to the interior side 206 of the lens 104B and the distance that the reflected infrared light 214 traveled from the interior side 206 of the lens 104B to the camera 108. A second distance can be a distance that the visible light 304 travels from the object 302 to the camera 108. The second distance is greater than the first distance. The camera 108 can alternate and/or adjust the focus distance between the first distance, while the camera 108 is capturing infrared light, and the second distance, while the camera 108 is capturing visible light. The alternation and/or adjustment of the focus distance can be implemented by a geometric phase lens included in the camera 108 that electronically switches between near focus (to capture images of the eye 110) and far focus (to capture images of the object 302). In some implementations, the camera 108 alternates between a first frame rate for capturing images of the eye 110 and a second frame rate for capturing images of the object 302. The first frame rate can be higher than the second frame rate. The first frame rate can be between 80 Hertz and 100 Hertz, such as 90 Hertz. The second frame rate can be between 5 Hertz and 15 Hertz, such as 10 Hertz.

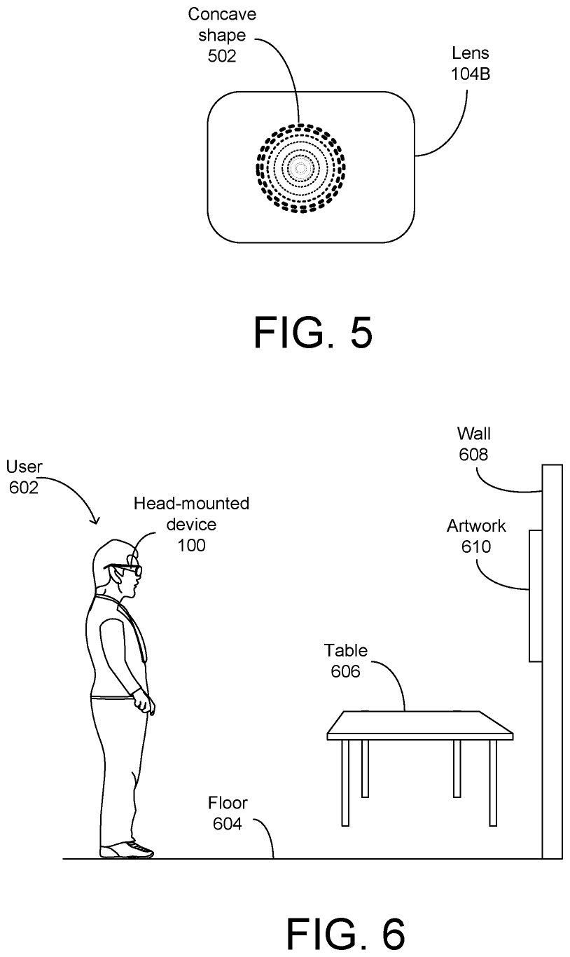

FIG. 4 shows a filter 400 included in the camera 108 (not shown in FIG. 4). The filter 400 can include an alternating grid of infrared-pass filters that pass infrared light and block visible light, and visible-pass filters that pass visible light and block infrared light. The filter 400 includes a filter array with alternating infrared-pass filters and visible-pass filters. The infrared-pass filters pass infrared light and block visible light. The visible-pass filters pass visible light and block infrared light. While FIG. 4 shows the filter 400 as a six-by-six grid of filters, the filter 400 can include any number of filters. In an example, the squares in which the shading has lines extending from the upper right to the lower left can be considered infrared-pass filters that pass infrared light and block visible light. In an example, the squares in which the shading has lines extending from the upper left to the lower right can be considered visible-pass filters that pass visible light and block infrared light. A portion of the filter 400, such as half, can pass infrared light and block visible light, and a portion of the filter 400, such as half, can pass visible light and block infrared light.

The camera 108 can also include a grid of photosensors corresponding to the grid of filters included in the filter 400. Photosensors included in the camera 108 that are aligned with and/or correspond to infrared-pass filters that pass infrared light and block visible light can detect infrared light, such as light scattering off of the eye 110 and reflecting off of the interior side 206. Photosensors included in the camera 108 that are aligned with and/or correspond to visible-pass filters that pass visible light and block infrared light can detect visible light, such as light scattering and/or reflecting off of an object such as the object 302 and passing through the lens 104B. In some examples, the photosensors included in the camera 108 that are aligned with and/or correspond to visible-pass filters are divided into four color channels corresponding to the four colors cyan, magenta, yellow, and black. The photosensors aligned with and/or corresponding to the visible-pass filters can sequentially alternate between the four color channels corresponding to the four colors cyan, magenta, yellow, and black. In some examples, the photosensors included in the camera 108 that are aligned with and/or correspond to visible-pass filters are divided into three color channels corresponding to the three colors red, green, and blue, and the photosensors aligned with and/or corresponding to the visible-pass filters can sequentially alternate between the three color channels corresponding to the three colors red, green, and blue.

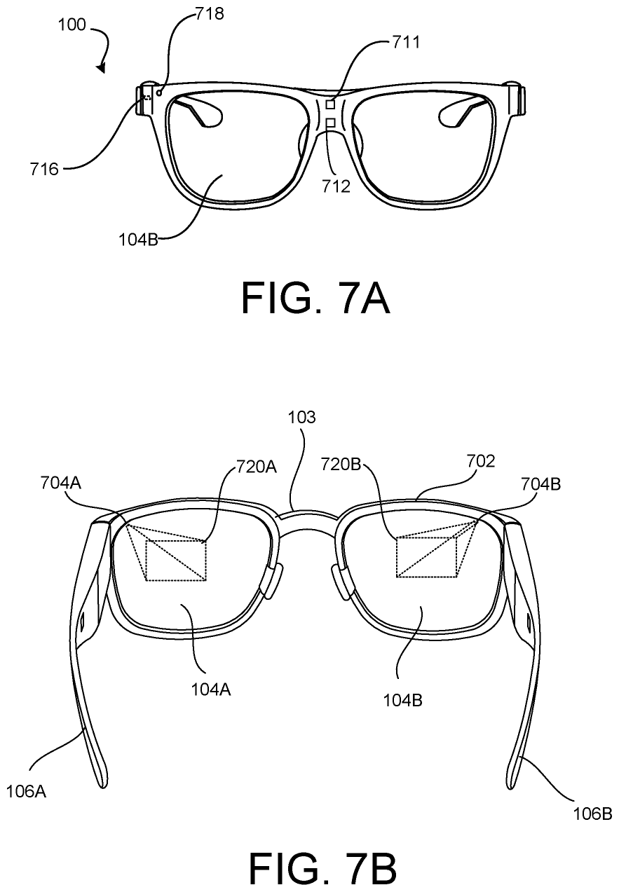

FIG. 5 shows the lens 104B with a concave shape 502. The concave shape 502 is part of the interior side 206 of the lens 104B. The concave shape 502 can extend across the entire interior side 206 of the lens 104B, or a portion of the interior side 206 of the lens 104B. The concave shape 502 is reflective. The concave shape 502 magnifies the image of the eye 110 that is reflected toward the camera 108. The magnified image provides greater detail of the eye 110, improving the accuracy of gaze tracking.

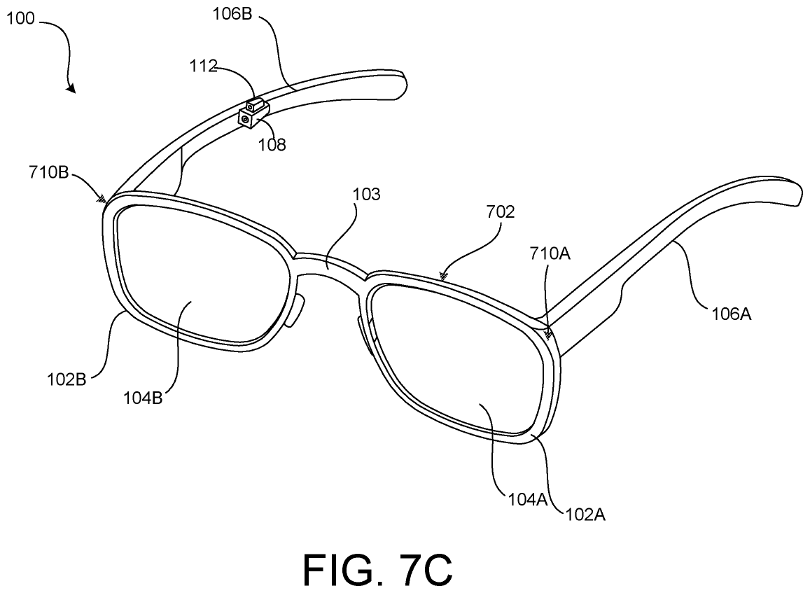

FIG. 6 shows the user 602 wearing the apparatus and objects around the user 602. In this example, the apparatus is a head-mounted device 100. Visible light reflected and/or scattered from various objects, such as a floor 604, a table 606, a wall 608, and/or artwork 610, can pass through the lens 104B and arrive at the camera 108. The floor 604, table 606, wall 608, and artwork 610 are examples of the object 302. The camera 108 can capture images of the objects. The head-mounted device 100 can determine orientation and/or movement of the head-mounted device 100 based at least in part on captured images of the objects.

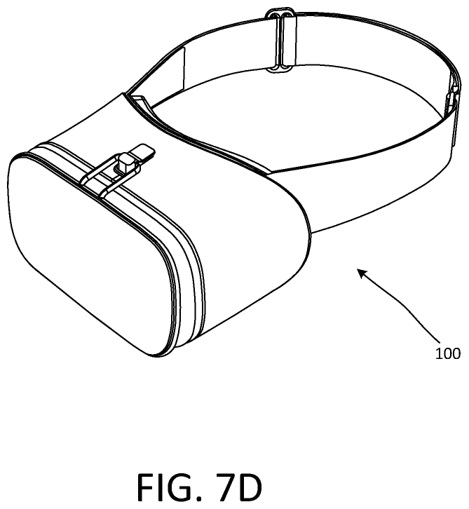

FIGS. 7A, 7B, and 7C show an implementation of the head-mounted device 100. As shown in FIGS. 7A, 7B, and 7C, the head-mounted device 100 includes a frame 702. The frame 702 includes a front frame portion defined by rim portions 102A, 102B surrounding respective optical portions in the form of lenses 104A, 104B, with a bridge portion 103 connecting the rim portions 102A, 102B. Temple arm portions 106A, 106B are coupled pivotably or rotatably coupled, to the front frame by hinge portions 710A, 710B at the respective rim portion 102A, 102B. In some implementations, the lenses 104A, 104B may be corrective/prescription lenses. In some implementations, the lenses 104A, 104B may be an optical material including glass and/or plastic portions that do not necessarily incorporate corrective/prescription parameters. The lenses 104A, 104B can include the hot mirror(s) on interior sides of the lenses 104A, 104B. Displays 704A, 704B may be coupled in a portion of the frame 702. In the implementation shown in FIG. 7B, the displays 704A, 704B are coupled to the temple arm portions 106A, 106B and/or rim portions 102A, 102B of the frame 702. In some implementations, the head-mounted device 100 can also include an audio output device 716 (such as one or more speakers), an illumination device 718, at least one processor 711, and at least one memory device 712. While FIG. 1 showed the processor 114 included in and/or coupled to the right temple arm 106B, the head-mounted device 100 can additionally or alternatively include a processor 711 in the frame 702. The at least one processor 711 can be configured to execute instructions to cause the head-mounted device 100 to perform any combination of methods, functions, and/or techniques described herein. The at least one memory device 712 can include a non-transitory computer-readable storage medium comprising instructions stored thereon that, when executed by a processor, such as the at least one processor 711 and/or the processor 114, cause the head-mounted device 100 to perform any combination of methods, functions, and/or techniques described herein.

In some implementations, the head-mounted device 100 may include a see-through near-eye display. The displays 704A, 704B may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world through the lenses 104A, 104B, next to content (such as digital images, user interface elements, virtual content, and the like) generated by the displays 704A, 704B. In some implementations, waveguide optics may be used to depict content on the displays 704A, 704B via outcoupled light 720A, 720B. The images projected by the displays 704A, 704B onto the lenses 104A, 104B may be translucent, allowing the user to see the images projected by the displays 704A, 704B as well as physical objects beyond the head-mounted device 100. The camera 108 and illuminator 112 are coupled to the right temple arm 106B.

FIG. 7D shows another implementation of the head-mounted device 100. In this implementation, the head-mounted device 100 is in goggle form, with a display included in the head-mounted device 100 and a housing supporting the display enclosing the face and/or eyes of a user. This implementation of the head-mounted device 100 can support a virtual reality (VR) experience in which the user sees only what is presented by the display included in the head-mounted device 100. In this implementation, the head-mounted device 100 can include a single lens that passes visible light and reflects infrared light on an interior side of the lens, and a camera on an interior portion of the sidewall that captured visible light passing through the lens and captures infrared images of an eye of the user that are reflected off of the lens.

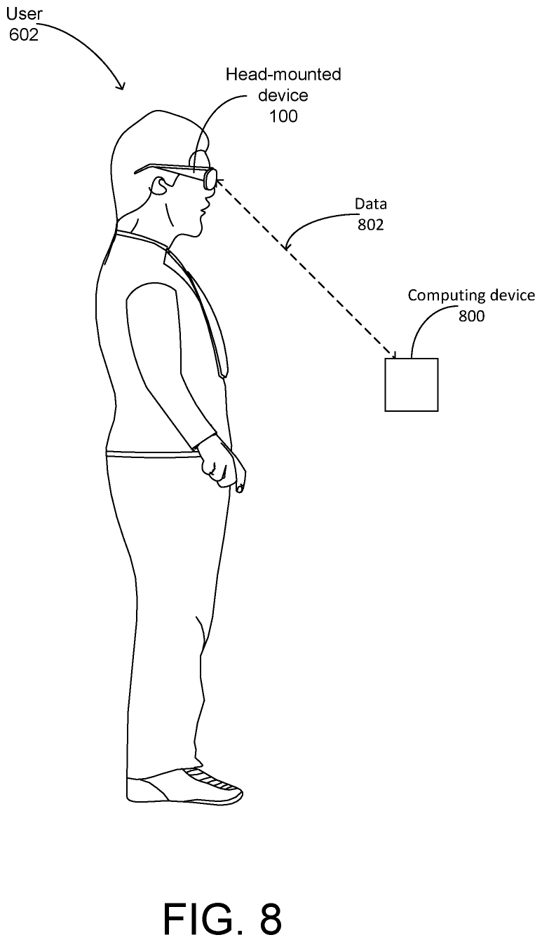

FIG. 8 shows the head-mounted device 100 communicating with a computing device 800 that is external to the head-mounted device 100. The head-mounted device 100 can distribute calculations between the head-mounted device 100 and the computing device 800. The head-mounted device 100 and computing device 800 can exchange data 802 based on calculations performed by the head-mounted device 100 and computing device 800. The head-mounted device 100 and computing device 800 can exchange data 802 via a wired or wireless connection. The computing device 800 can include, for example, a smartphone, a smartwatch, a tablet computing, a notebook or laptop computer, a desktop or tower computing, or a server, as non-limiting examples.

In some examples, the head-mounted device 100 performs the determinations and/or calculations of eye gaze direction and motion independently based on the captured images of the eye 110 and the measurements of the IMU 116. In some examples, the head-mounted device 100 performs measurements and/or gathers data, such as measurements performed by the IMU 116 and images captured by the camera 108, sends the measurements and/or data to the computing device 800, the computing device performs calculations and/or determinations such as gaze direction and/or motion, and sends the calculations and/or determinations to the head-mounted device 100. In some examples, the head-mounted device 100 determines the direction of the gaze based on the infrared images and sends IMU measurements and visible images captured by the camera 108 to the computing device 800, the computing device 800 determines the motion of the head-mounted device 100 based on the IMU measurements and visible images, and the computing device 800 sends the determined motion to the head-mounted device 100.

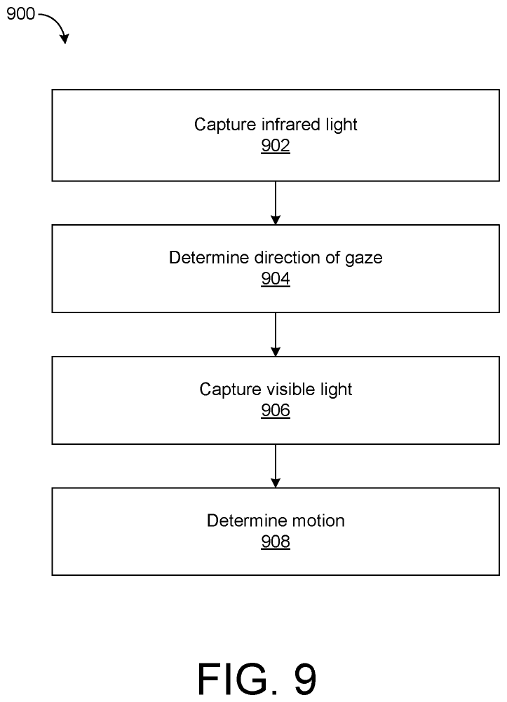

FIG. 9 shows a method 900 performed by the apparatus. The apparatus can include the head-mounted device 100. The method 900 can include capturing infrared light (902). Capturing infrared light (902) can include capturing, by a camera included in the head-mounted device, infrared light reflected off of a lens included in the head-mounted device, the infrared light including an image of an eye. The method 900 can include determining a direction of a gaze (904). Determining the direction of the gaze (904) can include determining, by a processor included in the head-mounted device based on the image of the eye, a direction of a gaze of the eye. The method 900 can include capturing visible light (906). Capturing visible light (906) can include capturing, by a camera included in the head-mounted device, visible light passing through the lens included in the head-mounted device, the visible light including an image of an object beyond the lens included in the head-mounted device. The method 900 can include determining motion (908). Determining motion (908) can include determining motion of the head-mounted device based on the image of the object.

In some examples, the method 900 further includes transmitting the infrared light onto the lens.

In some examples, the determining motion of the head-mounted device is based on the image of the object and inertial measurement data detected by an inertial measurement unit included in the head-mounted device.

In some examples, the method 900 further includes adjusting a focus distance of the camera from a first distance while capturing the infrared light to a second distance while capturing the visible light, the second distance being greater than the first distance.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A head-mounted device comprising:
a frame;
a lens coupled to the frame, the lens being configured to reflect infrared light from an interior side of the lens and pass visible light; and
a camera configured to capture the infrared light reflected from the interior side of the lens and to capture the visible light passing through the lens.

2. The head-mounted device of claim 1, wherein the lens comprises a hot mirror.

3. The head-mounted device of claim 1, wherein the camera comprises a filter array with alternating infrared-pass filters and visible-pass filters, the infrared-pass filters passing infrared light and blocking visible light, the visible-pass filters passing visible light and blocking infrared light.

4. The head-mounted device of claim 1, further comprising a processor configured to determine a gaze of an eye based on the infrared light captured by the camera.

5. The head-mounted device of claim 1, further comprising a processor configured to determine an orientation of the head-mounted device based on the visible light captured by the camera.

6. The head-mounted device of claim 1, further comprising a processor configured to:
determine a gaze of an eye based on the infrared light captured by the camera; and
determine an orientation of the head-mounted device based on the visible light captured by the camera.

7. The head-mounted device of claim 1, further comprising:
an inertial measurement unit,
wherein the head-mounted device is configured to determine motion of the head-mounted device based on the visible light and data detected by the inertial measurement unit.

8. The head-mounted device of claim 1, further comprising an infrared light source configured to reflect infrared light off of the lens and onto an eye of a user wearing the head-mounted device.

9. The head-mounted device of claim 1, wherein the interior side of the lens includes a concave shape.

10. The head-mounted device of claim 1, wherein the head-mounted device does not include an external camera on the frame.

11. The head-mounted device of claim 1, wherein the camera is configured to adjust a focus distance from a first distance while capturing the infrared light to a second distance while capturing the visible light, the second distance being greater than the first distance.

12. The head-mounted device of claim 1, wherein:
the head-mounted device further comprises a temple arm hingedly coupled to the frame; and
the camera is coupled to the temple arm.

13. A method performed by a head-mounted device, the method comprising:
capturing, by a camera included in the head-mounted device, infrared light reflected off of a lens included in the head-mounted device, the infrared light including an image of an eye;
determining, by a processor included in the head-mounted device based on the image of the eye, a direction of a gaze of the eye;
capturing, by a camera included in the head-mounted device, visible light passing through the lens included in the head-mounted device, the visible light including an image of an object beyond the lens included in the head-mounted device; and
determining motion of the head-mounted device based on the image of the object.

14. The method of claim 13, further comprising transmitting the infrared light onto the lens.

15. The method of claim 13, wherein the determining motion of the head-mounted device is based on the image of the object and inertial measurement data detected by an inertial measurement unit included in the head-mounted device.

16. The method of claim 13, further comprising adjusting a focus distance of the camera from a first distance while capturing the infrared light to a second distance while capturing the visible light, the second distance being greater than the first distance.

17. A non-transitory computer-readable storage medium comprising instructions stored thereon that, when executed by at least one processor, are configured to cause a head-mounted device to:
capture, by a camera included in the head-mounted device, infrared light reflected off of a lens included in the head-mounted device, the infrared light including an image of an eye;
determine, based on the image of the eye, a direction of a gaze of the eye;
capture, by the camera included in the head-mounted device, visible light passing through the lens included in the head-mounted device, the visible light including an image of an object beyond the lens included in the head-mounted device; and
determine motion of the head-mounted device based on the image of the object.

18. The non-transitory computer-readable storage medium of claim 17, wherein the instructions are further configured to cause the head-mounted device to transmit the infrared light onto the lens.

19. The non-transitory computer-readable storage medium of claim 17, wherein the determining motion of the head-mounted device is based on the image of the object and inertial measurement data detected by an inertial measurement unit included in the head-mounted device.

20. The non-transitory computer-readable storage medium of claim 17, wherein the instructions are further configured to cause the head-mounted device to adjust a focus distance of the camera from a first distance while capturing the infrared light to a second distance while capturing the visible light, the second distance being greater than the first distance.
